(19) United States
(12) Patent Application Publication
(10) Pub. No.: US 2008/0175564 A1
(43) Pub. Date: Jul. 24, 2008

(54) SYSTEM AND METHOD FOR PRESENTING SUPPLEMENTARY PROGRAM DATA UTILIZING PRE-PROCESSING SCHEME

(76) Inventor: Chi-Chun Lin, Tainan County (TW)

Correspondence Address: NORTH AMERICA INTELLECTUAL PROPERTY CORPORATION, P.O. BOX 506, MERRIFIELD, VA, 22116, US

(21) Appl. No.: 11/624,702

(22) Filed: Jan. 19, 2007

(51) Int. Cl. H04N 7/26

(52) U.S. Cl. 386/124

(57) ABSTRACT

A system for pre-processing supplementary program data is provided. The system includes: a storage device, for storing at least one supplementary program data unit; a parser, coupled to the storage device, for storing the supplementary program data unit in the storage device, and determining a presentation timing corresponding to the supplementary program data unit, the presentation timing including a presentation-on time; and a Presentation Unit (PU), coupled to the parser and the storage device, for pre-processing the supplementary program data unit to generate presentation content of the supplementary program data unit before the presentation-on time is reached, and for presenting the supplementary program data unit according to the presentation timing and the presentation content.

### BACKGROUND

Modern DVD systems include many supplementary program data, such as voice-over commentary, highlights, and subtitles. When presenting the supplementary program data, there is often a time lag between the presented main program content and the presented supplementary program data. For example, most multimedia files utilized in DVD systems have no included subtitle feature, and a separate file must be played together with the multimedia file. This file is a text file containing all the subtitle contents. When the subtitles to be displayed are in an alphabetic language such as English, all the required fonts can be pre-generated and stored in the non-volatile storage (e.g. a flash memory). For non-alphabetic languages, however, such as Chinese, the fonts are usually generated utilizing a run-time font generator, as the number of fonts is too large to be stored in the non-volatile storage.

In conventional systems, a buffer is utilized for storing subtitles to be displayed. As the buffer only has space for one subtitle, they are stored, processed and displayed one by one. A parser, (for example, a kernel) parses the encoded subtitles in the subtitle file and stores the parsed subtitle in the buffer. The encoded subtitle also includes a display-on time and a display-off time. When the display-on time of the parsed subtitle is reached, the parser notifies a Presentation Unit, (for example, a User Interface) which then generates the fonts of the subtitle and displays it. When the display-off time is reached, the parser notifies the User Interface (UI) to stop displaying the subtitle, and then removes the subtitle from the buffer.

For the above-mentioned case of non-alphabetic languages, the UI must utilize the run-time font generator for generating fonts for the text corresponding to the subtitle. As font generation takes a certain amount of time, but only begins when the parser notifies the UI (i.e. when the display-on time is reached), there will often be a time lag between the presentation of the audio speech and that of the corresponding subtitle text. Therefore, a novel and improved scheme for processing supplementary program data, such as subtitles, is required.

### SUMMARY

It is therefore an objective of the disclosed invention to provide a system for presenting supplementary program data that can avoid the time delay of conventional systems and related method thereof.

The system for presenting supplementary program data comprises: a storage device, for carrying at least one supplementary program data unit; a parser, coupled to the storage device, for parsing and storing the supplementary program data unit in the storage device, and determining a presentation timing corresponding to the supplementary program data unit, the presentation timing including a presentation-on time; and a Presentation Unit (PU), coupled to the parser and the storage device, for pre-processing the supplementary program data to generate presentation content of the supplementary program data before the presentation-on time is reached, and for presenting the supplementary program data according to the presentation-on time and the presentation content.

A method is further disclosed. The method comprises: providing a storage device; storing at least one supplementary program data unit in the storage device; determining a presentation timing corresponding to the supplementary program data unit, the presentation timing including a presentation-on time; pre-processing the supplementary program data to generate presentation content of the supplementary program data before the presentation-on time is reached; and presenting the supplementary program data according to the supplementary program data timing and the presentation content.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a system for processing supplementary program data according to an embodiment of the present invention.

FIG. 2 is a flowchart of the first operation of a parser shown in FIG. 1.

FIG. 3 is a flowchart of the second operating procedure of the parser shown in FIG. 1.

FIG. 4 is a flowchart of the operation of the PU shown in FIG. 1.

### DETAILED DESCRIPTION

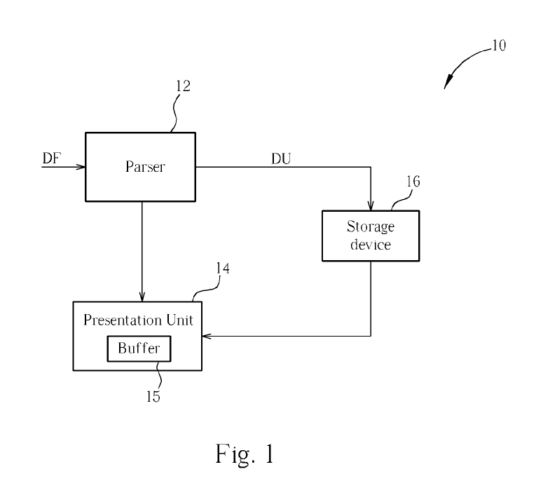

Please refer to FIG. 1. FIG. 1 is a block diagram illustrating a system 10 for processing supplementary program data according to an embodiment of the present invention. The system 10 includes a parser 12, a Presentation Unit (PU) 14 having a buffer 15, and a storage device 16. The storage device is implemented to store supplementary program data unit DU. The parser 12 is coupled to the storage device 16 and the PU 14 for receiving a supplementary program data source DF, parsing the supplementary program data source DF to output the supplementary program data units to the storage device 16, and determining presentation timing corresponding to each supplementary program data unit, where the presentation timing includes a presentation-on time and a presentation-off time. Please note that the parser 12 can be a kernel in some embodiments, the PU 14 may be a User Interface in some embodiments, and this also falls within the scope of the present invention. The presentation timing can be display timing, and the term display will be used herein with reference to this embodiment. These terms merely refer to the currently described embodiment, however, and are in no way meant to limit the scope or implementation of the present invention. The PU 14 accesses the storage device 16 for pre-processing the buffered supplementary program data unit DU to generate presentation content before the presentation-on time of the supplementary program data unit DU is reached, and for presenting the supplementary program data according to the presentation timing and the presentation content. Additionally, one embodiment of pre-processing is font generation for generating non-alphabetic fonts. The operation of the system 10 is detailed as follows.

It should be noted that the present invention provides a storage device 16 for enabling the pre-processing of supplementary program data. In the following description, the storage device 16 is implemented by a queue, the PU buffer 15 is implemented by a font buffer, or User Interface buffer, the supplementary program data source DF is a subtitle source, and each supplementary program data unit DU corresponds to a subtitle. Additionally, the parser 12 will herein be referred to as a kernel, and the Presentation Unit 14 will herein be referred to as a User Interface (UI). Please note, however, that this is merely one embodiment and is not meant to be a limitation of the disclosed invention. For example, the supplementary program data unit can include closed caption data, picture data, symbol data, logo data, or audio data in other embodiments of the present invention.

The disclosed invention includes the queue 16 that can store a plurality of subtitles DU at the same time. The maximum number of subtitles DU the queue 16 can store at any one time can be modified according to design requirements and is not a limitation of the present invention. Initially the queue 16 is empty. The kernel 12 parses the subtitle source DF and enters a first subtitle in the queue 16. The UI 14 starts to generate fonts for the first subtitle immediately, and stores the corresponding font information in the UI buffer 15. The kernel 12 continues to store subtitles DU in the queue 16 until the queue 16 is full, while the UI 14 similarly continues to pre-process entered subtitles DU and store the corresponding font information in the UI buffer 15.

When the display-on time of the first subtitle is reached, the kernel 12 will inform the UI 14, which then displays the desired subtitle. As the fonts for the corresponding text have already been generated through the pre-processing scheme there will be no time delay between the required display time and the actual display time. When the display-off time is reached, the kernel 12 will inform the UI 14 to stop displaying the subtitle. At this point the kernel 12 will remove the first subtitle from the queue 16, and the UI 14 will similarly remove the corresponding font information from the UI buffer 15. As there is now a free entry in the queue 16, the kernel 12 will add another subtitle DU parsed from the subtitle file DF, which will then be immediately pre-processed by the UI 14 before its display-on time is reached.

Please note that the UI 14 comprises a UI buffer 15 for storing the display content for subtitles. The kernel 12 identifies timing information of the encoded data from the subtitle file DF, which it utilizes for informing the UI 14 when to display and stop displaying the subtitle. After stopping displaying a certain subtitle, the UI 14 will then remove the corresponding display content from the UI buffer 15.

As mentioned above, the utilization of the queue 16 enables pre-processing to be performed on the stored encoded supplementary program data (i.e. the subtitle data). As soon as the kernel 12 determines that the queue 16 has an entry, it will send the corresponding text, length, and index of a subtitle to the queue 16. Then, fonts are generated by the UI 14 for the text and stored in the UI buffer 15. When the display-on time of the subtitle is reached, the kernel 12 will notify the UI 14 utilizing the index of the subtitle. The UI 14 can therefore access the fonts for the subtitle in the UI buffer 15 and display it. Similarly, when the display-off time of the subtitle is reached, the kernel 12 will notify the UI 14 utilizing the index of the subtitle.

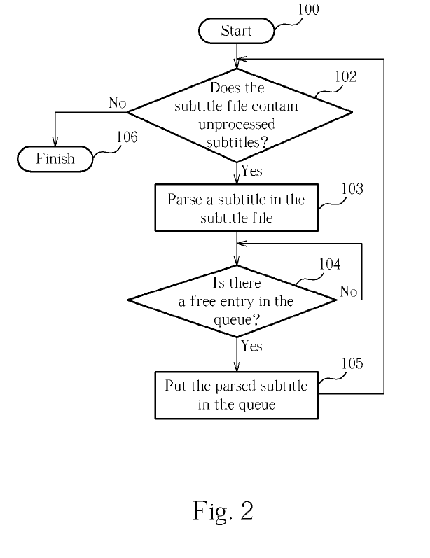

Please refer to FIG. 2. FIG. 2 is a flowchart of the first operation of the kernel 12. The steps are as follows:
Step 100: Start;
Step 102: Does the subtitle file contain un-processed subtitles? If yes go to Step 103, if no go to Step 106;
Step 103: Parse a subtitle in the subtitle file;
Step 104: Is there a free entry in the queue? If yes go to Step 105, if no go back to Step 104 to wait for a free entry;
Step 105: Put the parsed subtitle in the queue and go back to Step 102;
Step 106: Finish.

The process begins (Step 100). The kernel 12 will add subtitles to the queue 16 one by one, by first searching the subtitle file from the beginning to determine if a subtitle needs to be displayed (Step 102), then parse the subtitle in the subtitle file (Step 103). The kernel 12 then has to determine if there is available space in the queue 16 (Step 104), wherein if there is available space, the kernel 12 will put the parsed subtitle in the queue 16 (Step 105), and if there is no space the kernel 12 will wait until the queue 16 has available space (Step 104). When all subtitles carried by the subtitle file have been parsed, the process will end (Step 106).

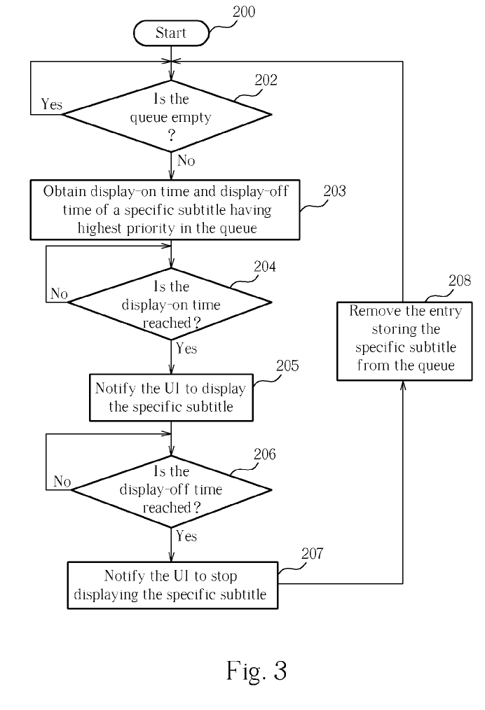

Please refer to FIG. 3. FIG. 3 is a flowchart of the second operating procedure of the kernel 12. The steps are as follows:
Step 200: Start;
Step 202: Is the queue empty? If no go to Step 203, if yes go back to Step 202;
Step 203: Obtain display-on time and display-off time of a specific subtitle having the highest queue priority in the queue;
Step 204: Is the display-on time reached? If yes go to Step 205, if no go back to Step 204;
Step 205: Notify the UI 14 to display the specific subtitle;
Step 206: Is the display-off time reached? If yes go to Step 207, if no go back to Step 206;
Step 207: Notify the UI 14 to stop displaying the specific subtitle;
Step 208: Remove the entry storing the displayed specific subtitle from the queue and go back to Step 202;

The process begins (Step 200). The kernel 12 first determines if there is an entry storing a subtitle in the queue 16 (Step 202) and then determines the display-on and display-off times of the subtitle stored in an entry corresponding to a highest queue priority (Step 203). The subtitle with an earliest display-on time among the subtitles in the queue 16 has the highest queue priority and is processed first. Further description related to queue operation is omitted for brevity. When the display-on time is reached (Step 204) the kernel 12 will notify the UI 14 to display the specific subtitle (Step 205); similarly when the display-off time is reached (Step 206) the kernel 12 will notify the UI 14 to stop displaying the specific subtitle (Step 207). Finally the kernel 12 will remove the displayed specific subtitle from the queue 16 (Step 208). The process will then continue for the next entered subtitle. Since the entry storing the displayed subtitle is removed, the entry storing the next entered subtitle has the highest queue priority instead, and the next entered subtitle becomes the specific subtitle selected in step 203.

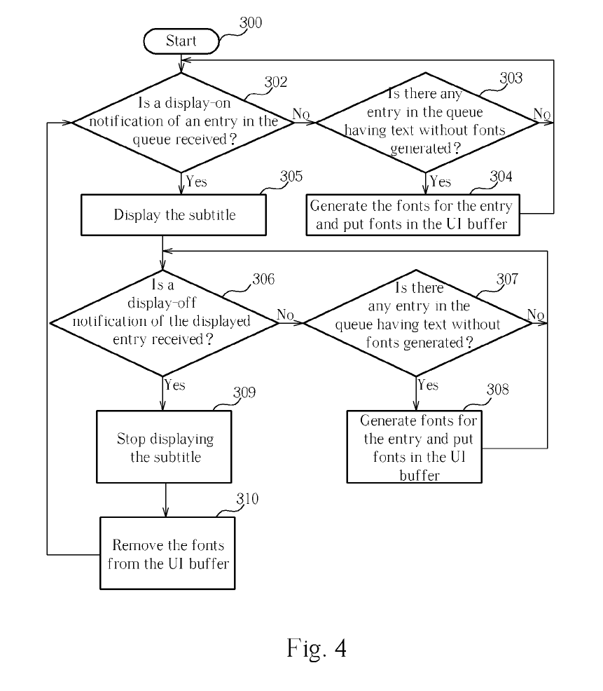

Finally please refer to FIG. 4. FIG. 4 is a flowchart of the operation of the UI 14. The steps are illustrated as follows:
Step 300: Start;
Step 302: Is a display-on notification of an entry in the queue received? If yes go to Step 305, if no go to Step 303;
Step 303: Is there any entry in the queue having text without fonts generated? If yes go to Step 304, if no go back to Step 302;
Step 304: Generate the fonts for a part of the text of the entry and put fonts in the UI buffer. Go back to Step 302;
Step 305: Display the subtitle corresponding to the entry;
Step 306: Is a display-off notification of the displayed entry received? If yes go to Step 309, if no go to Step 307
Step 307: Is there any entry in the queue having text without fonts generated? If yes go to Step 308, if no go back to Step 306;
Step 308: Generate the fonts for a part of the text of the entry and put fonts in the UI buffer. Go back to Step 306;
Step 309: Stop displaying the subtitle;
Step 310: Remove the fonts for the subtitle from the UI buffer. Go back to Step 302.

The process begins (Step 300). First, the UI 14 checks if there is a display-on notification received from the kernel 12 (Step 302); if no, it then determines if there is any entry in the queue 16 having text without fonts completely generated (Step 303); if so, the pre-processing scheme is activated. The UI 14 will obtain the text information of the entry in the queue 16 and then generate fonts for a part of the text of the entry (Step 304), where the fonts generated are stored in the UI buffer 15. Then, the process goes back to Step 302 for checking the display-on notification again. If there is still no display-on notification received, the UI 14 continues to generate fonts for another part of the text of the entry until it has received a display-on notification or all fonts have been generated. After receiving the notification, the UI 14 will display the subtitle corresponding to the specific entry (Step 305). If a display-off notification of the specific entry is received (Step 306) the UI 14 will stop displaying the subtitle (Step 309). At this point the UI 14 will remove the corresponding font information from the UI buffer 15, and then return to Step 302 to keep detecting the status of the queue 16 and the notification from the kernel 12. During the display of the presently displayed subtitle, if a display-off notification has not arrived yet, the UI 14 will keep checking if there is any entry in the queue 16 having text without fonts generated (Step 307), and then generate fonts if necessary (Step 308).

As mentioned above, the size of the queue 16 can be altered according to design requirements. The amount of data that can be stored at any one time depends on the processing rate of the font generator of the UI 14, as all data stored in the queue 16 must be pre-processed. If the font processing rate of the UI 14 is R (bytes/s), the data amount of a certain subtitle is L (bytes) and the time between the display-on time of that subtitle and the display-on time of its previous subtitle is t (s), the value L/t for each subtitle in the subtitle file is calculated. Let the maximum possible L/t be denoted as L_{M}/t_{M}. If R is greater than or equal to L_{M}/t_{M} then the queue 16 is required to be capable of storing at least one byte of subtitle data.

If R>=L_{M}/t_{M} queue_{DATA}=I byte Inequality (1)

In contrast, if R is less than L_{M}/t_{M}, the queue 16 should be able to store t_{M}*(L_{M}/t_{M}−R) bytes of subtitle data.

If R<L_{M}/t_{M} queue_{DATA}=t_{M}*(L_{M}/t_{M}−R) bytes Inequality (2)

As all data stored in the queue is pre-processed, there is no time lag between a required display-on time and an actual display-on time of the subtitles. Furthermore, as the data in the queue 16 is processed as soon as it is entered into the queue 16, and removed when a display-off time is reached, the process of adding and removing subtitles can proceed continuously. This ensures that there will always be sufficient time for processing data in the queue 16 before the corresponding display-on time is reached.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system for presenting supplementary program data, the system comprising:
a storage device, for storing at least one supplementary program data unit;
a parser, coupled to the storage device, for parsing the supplementary data unit in the storage device, and determining a presentation timing corresponding to the supplementary program data unit, the presentation timing including a presentation-on time; and
a Presentation Unit (PU), coupled to the parser and the storage device, for pre-processing the supplementary program data unit to generate presentation content before the presentation-on time is reached, and for presenting the supplementary program data unit according to the presentation timing and the presentation content.

2. The system of claim 1, wherein the storage device is a queue for storing a plurality of supplementary program data units.

3. The system of claim 2, wherein the parser continuously parses supplementary program data units into the queue until the queue is full.

4. The system of claim 2, wherein the presentation timing further includes a presentation-off time, and when the presentation-off time is reached the parser removes the supplementary program data unit from the queue.

5. The system of claim 2, wherein the parser stores data in the queue by determining a data size of a specific supplementary program data.

6. The system of claim 5, further comprising:
a supplementary program data source containing the supplementary program data units;
wherein the parser parses the supplementary program data source for determining a data size of each supplementary program data unit.

7. The system of claim 1, wherein the presentation timing further includes a presentation-off time, and when the presentation-off time is reached the parser removes the supplementary program data unit from the storage device.

8. The system of claim 1, wherein the supplementary program data unit comprises subtitle data, closed caption data, picture data, symbol data, logo data or audio data.

9. The system of claim 1, wherein the supplementary program data unit is a subtitle, and pre-processing of the subtitle generates presentation content.

10. The system of claim 9, further comprising:
a subtitle file containing the subtitles;
wherein the parser parses the subtitle file for determining a data size of each subtitle.

11. A method for presenting supplementary program data, the method comprising:
storing at least one supplementary program data unit;
determining a presentation timing corresponding to the supplementary program data unit, the presentation timing including a presentation-on time;
pre-processing the supplementary program data unit to generate presentation content of the supplementary program data unit before the presentation-on time is reached; and
presenting the supplementary program data unit according to the presentation timing and the presentation content.

12. The method of claim 11, wherein the step of storing at least one supplementary program data unit comprises:
providing a storage and utilizing the storage to store a plurality of supplementary program data units.

13. The method of claim 12, wherein the step of storing at least one supplementary program data unit further comprises:
continuously storing supplementary program data units in the storage until the storage is full.

14. The method of claim 12, wherein the presentation timing further includes a presentation-off time, and the step of presenting the supplementary program data unit according to the presentation timing and the presentation content further comprises:
when the presentation-off time is reached, removing the supplementary program data unit from the storage.

15. The method of claim 12, wherein the step of storing at least one supplementary program data unit further comprises:
determining a data size of a specific supplementary program data unit.

16. The method of claim 12 wherein the step of storing at least one supplementary program data unit further comprises:
receiving a supplementary program data source containing the supplementary program data units; and
parsing the supplementary program data file for determining a data size of each supplementary program data unit.

17. The method of claim 11, wherein the presentation timing further includes a presentation-off time, and the step of presenting the supplementary program data unit according to the presentation timing and the presentation content further comprises:
when the presentation-off time is reached, removing the stored supplementary program data unit.

18. The method of claim 11, wherein the supplementary program data unit includes subtitle data, closed caption data, picture data, symbol data, logo data or audio data.

19. The method of claim 11, wherein the supplementary program data unit is a subtitle, and pre-processing of the subtitle generates presentation content.
